(19) United States
(12) Patent Application Publication
(10) Pub. No.: US 2026/0078708 A1
(43) Pub. Date: Mar. 19, 2026

(54) UNIT MANAGEMENT SYSTEM, ELECTRIC POWER GENERATING UNIT, MANAGEMENT SUPPORT EQUIPMENT, AND UNIT MANAGEMENT METHOD

(71) Applicant: KAWASAKI MOTORS, LTD., Akashi-shi, Hyogo (JP)

(72) Inventor: Yoshimoto MATSUDA, Akashi-shi (JP)

(21) Appl. No.: 19/108,556

(22) PCT Filed: Aug. 24, 2023
(86) PCT No.: PCT/JP2023/030446

§ 371 Date: Mar. 4, 2025

(30) Foreign Application Priority Data
Sep. 5, 2022 (JP) 2022-140955

(51) Int. Cl. F02D 29/06; F02B 43/12; F02B 63/04; H02K 7/18

(52) U.S. Cl. CPC F02D 29/06; F02B 43/12; F02B 63/042; H02K 7/1815

(57) ABSTRACT

A unit management system includes: electric power generating units that generate electric power; and management support equipment that receives information from the electric power generating units. Each of the electric power generating units includes: an internal combustion engine; an electric power generator that generates the electric power by rotational power of the internal combustion engine; a communication interface that is communicable with the management support equipment; and unit control circuitry configured to associate state information with unit identification information and transmit the state information and the unit identification information to the management support equipment through the communication interface, the state information indicating a state of the electric power generating unit, the unit identification information being information for identifying the electric power generating unit.

### CROSS-REFERENCE TO RELATED APPLICATION

### Technical Field

This application claims priority to and the benefit of Japanese Patent Application No. 2022-140955 filed on Sep. 5, 2022, the entire disclosure of which is incorporated herein by reference.

### Field

The present disclosure relates to a unit management system, an electric power generating unit, management support equipment, and a unit management method.

### BACKGROUND ART

A car including an internal combustion engine has been known. For example, PTL 1 discloses a car which includes an internal combustion engine capable of operating by using hydrogen as fuel and advances when the rotation of an output shaft by the internal combustion engine is transmitted to a driving wheel.

### CITATION LIST

### Patent Literature

PTL 1: Japanese Laid-Open Patent Application Publication No. 2008-038680

### SUMMARY OF INVENTION

### Technical Problem When there is an abnormality in the internal combustion engine, a movable body may not be able to operate until the elimination of the abnormality.

An object of the present disclosure is to provide a unit management system, an electric power generating unit, management support equipment, and a unit management method, each of which facilitates the continuation of the operation of a driving source.

### Solution to Problem

A unit management system according to one aspect of the present disclosure includes: electric power generating units that generate electric power; and management support equipment that receives information from the electric power generating units. Each of the electric power generating units includes: an internal combustion engine; an electric power generator that generates the electric power by rotational power of the internal combustion engine; a communication interface that is communicable with the management support equipment; and unit control circuitry configured to associate state information with unit identification information and transmit the state information and the unit identification information to the management support equipment through the communication interface, the state information indicating a state of the electric power generating unit, the unit identification information being information for identifying the electric power generating unit.

An electric power generating unit according to one aspect of the present disclosure includes: an internal combustion engine; an electric power generator that generates electric power by rotational power of the internal combustion engine; a communication interface; and unit control circuitry configured to associate state information with unit identification information and transmit the state information and the unit identification information to external equipment through the communication interface, the state information indicating a state of the electric power generating unit, the unit identification information being information for identifying the electric power generating unit.

Management support equipment according to one aspect of the present disclosure is management support equipment that receives information from electric power generating units that generate electric power. The management support equipment includes: a communication interface that receives unit identification information and state information from each electric power generating unit, the unit identification information being information for identifying the electric power generating unit, the state information being associated with the unit identification information and indicating a state of the electric power generating unit; a memory that stores the received state information associated with the unit identification information; and processing circuitry configured to generate management support information based on the state information stored in the memory, the management support information being information for managing the electric power generating unit corresponding to the unit identification information associated with the state information.

A unit management method according to one aspect of the present disclosure is a unit management method of managing electric power generating units that generate electric power. The unit management method includes: acquiring state information from each electric power generating unit, the state information indicating a state of the electric power generating unit; and outputting management support information based on the acquired state information, the management support information being information for managing the electric power generating unit.

### Advantageous Effects of Invention

The present disclosure can provide the unit management system, the electric power generating unit, the management support equipment, and the unit management method, each of which facilitates the continuation of the operation of the driving source.

### BRIEF DESCRIPTION OF DRAWINGS

FIG. 1 is a schematic configuration diagram of a movable body including a unit management system according to Embodiment 1.

FIG. 2 is a block diagram of a drive system of the movable body shown in FIG. 1.

FIG. 3A is a schematic perspective view showing one example of an electric power generating unit. FIG. 3B is a schematic perspective view showing another example of the electric power generating unit.

FIG. 4 is a block diagram showing the flow of information in the unit management system shown in FIG. 1.

FIG. 5 is a table showing, as one example, contents of control commands transmitted to internal combustion engines in the electric power generating units and output electric powers corresponding to the control commands.

FIG. 6 is a table showing unit identification information, temperature information corresponding to the unit identification information, and maintenance information corresponding to the unit identification information.

FIG. 7 shows one example of a fuel consumption rate map of the internal combustion engine for explaining a control method of an integration ECU.

FIG. 8 is a diagram for explaining a maintenance method of the movable body.

FIG. 9 is a schematic configuration diagram of a maintenance management system including the unit management system according to Embodiment 2.

FIG. 10 is a block diagram showing the flow of the information in the unit management system shown in FIG. 9.

FIG. 11 is a diagram showing a configuration example of data stored by maintenance support equipment.

### DESCRIPTION OF EMBODIMENTS

Hereinafter, embodiments will be described with reference to the drawings.

### Embodiment 1

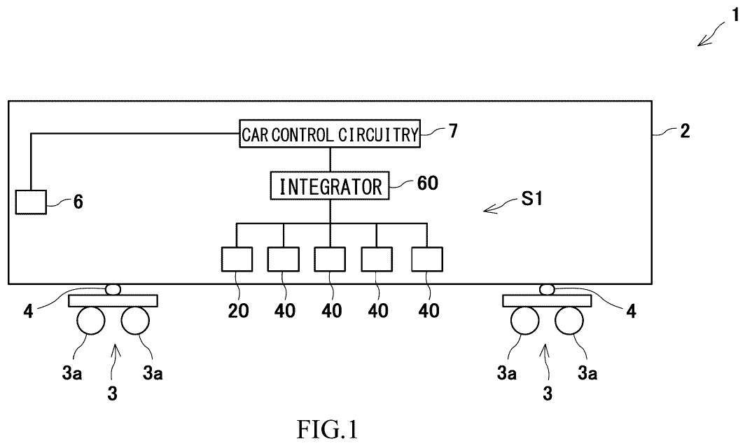

FIG. 1 is a schematic configuration diagram of a movable body 1 including a unit management system S1 according to Embodiment 1. The unit management system S1 according to the present embodiment includes at least one electric power generating unit 40, at least one fuel supply unit 20, and an integrator 60. The integrator 60 of the present embodiment is one example of management support equipment. Details of the fuel supply unit 20, the electric power generating unit 40, and the integrator 60 will be described later.

In the present embodiment, a railcar 1 is described as the movable body 1. The railcar 1 includes a carbody 2 and a pair of bogies 3. The bogies 3 are respectively located close to both longitudinal-direction end portions of the carbody 2 and support the carbody 2. In the railcar 1, a bolster spring 4 is located between the carbody 2 and each bogie 3.

The railcar 1 is, for example, a passenger car. The carbody 2 includes a passenger room and a driver's cab. The passenger room accommodates occupants. The driver's cab is located at a longitudinal-direction end portion of the carbody 2. Each bogie 3 includes wheels 3a. Two wheels 3a which are lined up so as to be spaced apart from each other in a car width direction are coupled to each other by an axle. However, the bogie 3 may be of an independently rotating wheel type in which two wheels 3a are not coupled to each other by the axle.

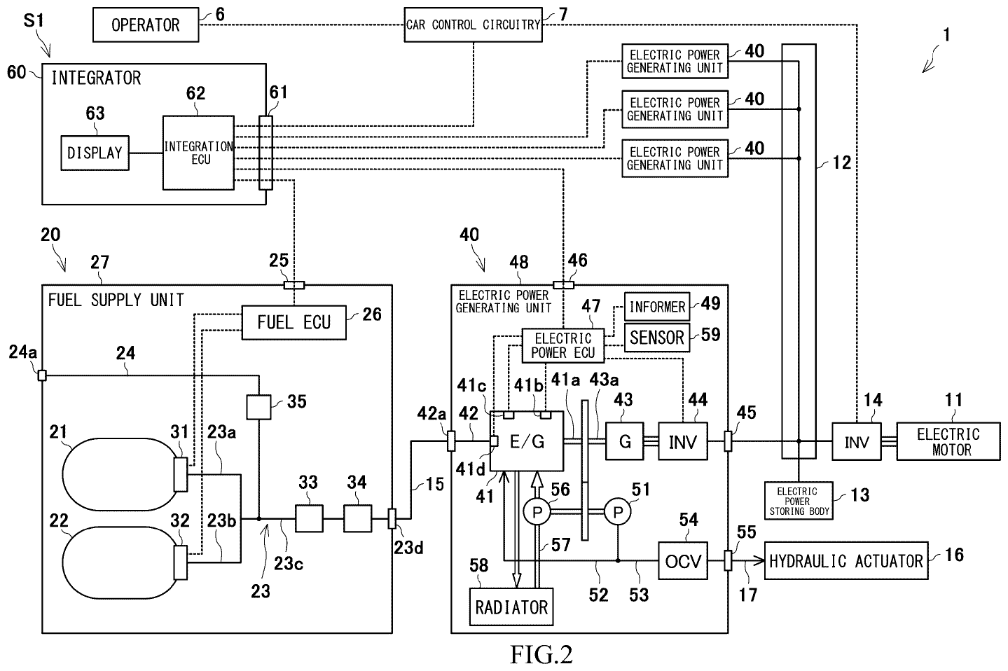

The railcar 1 is a motor car. The railcar 1 includes at least one electric motor 11 (see FIG. 2) that is an advancing power generator. An output shaft of each electric motor 11 is coupled to at least one wheel 3a through a power transmitting structure. Each electric motor 11 rotates the corresponding wheel 3a. The electric motor 11 is fixed to the bogie 3. The railcar 1 may adopt a carbody-mounted Cardan driving system. To be specific, the electric motor 11 may be fixed to the carbody 2.

The railcar 1 includes an operator 6 and car control circuitry 7 configured to be communicable with the operator 6. The operator 6 includes one or more levers or one or more handles located at the driver's cab. A requirement command is transmitted from the operator 6 to the car control circuitry 7 in accordance with an operation input of a driver with respect to the operator 6. The requirement command includes a traveling command and a braking command. The operator 6 includes: a traveling operator to which the traveling command is input; a braking operator to which the braking command is input; and the like. The traveling operator may be located separately from the braking operator or may be integrated with the braking operator.

Based on the requirement command received from the operator 6, the car control circuitry 7 generates an output command for controlling the electric motor 11 mounted on the railcar 1. The car control circuitry 7 transmits the output command to an inverter 14 (see FIG. 2) that controls the output of the electric motor 11. The electric power necessary to drive the electric motor 11 is supplied from at least one electric power generating unit 40.

The car control circuitry 7 includes a processor, a system memory, and a storage memory. The processor includes, for example, a central processing unit (CPU). The system memory is, for example, a RAM. The storage memory may include a ROM. The storage memory may include a hard disk, a flash memory, or a combination thereof. The storage memory stores a program.

In the present embodiment, the electric power generating units 40 are mounted on the carbody 2. For example, four electric power generating units 40 are mounted on the carbody 2. Each electric power generating unit 40 generates electric power to be supplied to at least one electric motor 11. Moreover, one fuel supply unit 20 is mounted on the carbody 2. The fuel supply unit 20 supplies fuel, necessary to generate the electric power, to the electric power generating unit 40. Moreover, the integrator 60 is mounted on the carbody 2. The integrator 60 collects information of all of the electric power generating units 40 and the fuel supply unit 20 mounted on the carbody 2.

FIG. 2 is a block diagram of a drive system that drives the electric motor 11. For simplicity, FIG. 2 shows only one electric motor 11 included in the railcar 1. Before describing the fuel supply unit 20, the electric power generating unit 40, and the integrator 60 which constitute the unit management system S1, a destination to which the electric power is supplied from the electric power generating unit 40 will be described first.

The railcar 1 includes electric power collecting circuitry 12, an electric power storing body 13, and the inverter 14. The electric power generating units 40 of the railcar 1 are electrically connected to the electric power collecting circuitry 12 through, for example, an electric cable in parallel. The electric power collecting circuitry 12 collects the electric power generated by the electric power generating units 40.

The electric power generating units 40 are electrically connected to the electric power storing body 13 through the electric power collecting circuitry 12. The electric power storing body 13 stores the electric power generated by the electric power generating units 40. The electric power storing body 13 is, for example, a battery or a capacitor. Moreover, the electric power storing body 13 is electrically connected to the electric motor 11 through the inverter 14.

The inverter 14 converts DC power into AC power, adjusts the voltage of the AC power, and supplies the AC power to the electric motor 11. The inverter 14 controls the output of the electric motor 11 based on the output command transmitted from the car control circuitry 7.

### Configuration of Fuel Supply Unit

The fuel supply unit 20 supplies a hydrogen gas as the fuel to an internal combustion engine 41 of the electric power generating unit 40. As shown in FIG. 2, the fuel supply unit 20 includes a first fuel tank 21, a second fuel tank 22, a supply pipe 23, a filling pipe 24, a communication interface 25, fuel control circuitry 26, a support structural body 27, and the like. The fuel control circuitry 26 is also called a fuel ECU (Electronic Control Unit) 26.

The first fuel tank 21 and the second fuel tank 22 are the same in structure as each other. The first fuel tank 21 and the second fuel tank 22 store the hydrogen gas as a fuel gas in a compressed state. Each of internal pressure of the first fuel tank 21 in a full state and internal pressure of the second fuel tank 22 in a full state is higher than atmospheric pressure, specifically higher than predetermined intake pressure of the internal combustion engine 41.

A first on-off valve 31 is located at the first fuel tank 21 and opens and closes a port of the first fuel tank 21. A second on-off valve 32 is located at the second fuel tank 22 and opens and closes a port of the second fuel tank 22. The first on-off valve 31 and the second on-off valve 32 are electromagnetic valves that are electrically controllable.

The supply pipe 23 guides the fuel from the first fuel tank 21 and the second fuel tank 22 to the electric power generating unit 40. Two upstream end portions of the supply pipe 23 are connected to the first fuel tank 21 and the second fuel tank 22. Moreover, one downstream end portion of the supply pipe 23 includes a supply port 23d.

More specifically, the supply pipe 23 includes a first sub-supply pipe 23a, a second sub-supply pipe 23b, and a main supply pipe 23c. The first sub-supply pipe 23a connects the first fuel tank 21 to the main supply pipe 23c. The second sub-supply pipe 23b connects the second fuel tank 22 to the main supply pipe 23c. To be specific, the first sub-supply pipe 23a and the second sub-supply pipe 23b extend from the main supply pipe 23c at an upstream portion of the main supply pipe 23c. A downstream end portion of the main supply pipe 23c includes the supply port 23d.

A pressure reducing valve 33 is located at the main supply pipe 23c. The pressure reducing valve 33 reduces the pressure of the hydrogen gas, which flows through the main supply pipe 23c, such that the pressure of the hydrogen gas to be supplied from the main supply pipe 23c to the internal combustion engine 41 is maintained at the predetermined intake pressure.

A shutoff valve 34 is located at a portion of the main supply pipe 23c which is located downstream of the pressure reducing valve 33. The shutoff valve 34 is located at the main supply pipe 23c so as to be able to shut off the supply of the hydrogen gas from the main supply pipe 23c to the internal combustion engine 41 in an emergency, for example.

The filling pipe 24 is a pipe through which the fuel is guided from an outside to the first fuel tank 21 and the second fuel tank 22. One end portion of the filling pipe 24 is connected to a portion of the main supply pipe 23c which is located upstream of the pressure reducing valve 33. The other end portion of the filling pipe 24 includes a filling port 24a. A check valve 35 is located at the filling pipe 24 and prevents the fuel from flowing toward the filling port 24a.

The communication interface 25 connects the fuel ECU 26 to the integrator 60, located outside the fuel supply unit 20, such that the fuel ECU 26 is communicable with the integrator 60. In the case of wired communication, the communication interface 25 is a detachable terminal or a detachable communication connector. In the case of wireless communication, the communication interface 25 is a known wireless communicator.

The fuel ECU 26 controls the first on-off valve 31 and the second on-off valve 32 based on a signal received from the integrator 60 through the communication interface 25. The fuel ECU 26 includes a processor, a system memory, and a storage memory. The processor includes, for example, a central processing unit (CPU). The system memory is, for example, a RAM. The storage memory may include a ROM. The storage memory may include a hard disk, a flash memory, or a combination thereof. The storage memory stores a program.

The components 21, 22, 23, 24, 25, 26, 31, 32, 33, 34, and 35 included in the fuel supply unit 20 are fixed to each other and integrated with each other. Specifically, the components 21, 22, 23, 24, 25, 26, 31, 32, 33, 34, and 35 included in the fuel supply unit 20 are supported by the support structural body 27 and are combined as a unit. For example, the support structural body 27 has a cuboidal box shape. The components 21, 22, 23, 24, 25, 26, 31, 32, 33, 34, and 35 (except for the support structural body 27) included in the fuel supply unit 20 are accommodated in the box-shaped support structural body 27 and are directly or indirectly connected and fixed to the support structural body 27.

The support structural body 27 is attachable to and detachable from the carbody 2 while keeping supporting the fuel tanks 21 and 22. To be specific, the fuel supply unit 20 is detachably mounted on the carbody 2. The fuel supply unit 20 is replaceable with another fuel supply unit 20 having the same structure.

Configuration of Power Generating Unit The electric power generating unit 40 includes the internal combustion engine 41, a fuel pipe 42, an electric power generator (motor generator) 43, an inverter 44, an electric interface 45, a communication interface 46, electric power control circuitry 47, an informer 49, and the like. The electric power control circuitry 47 is also called an electric power ECU (Electronic Control Unit) 47. The electric power control circuitry 47 is one example of unit control circuitry.

The internal combustion engine 41 combusts the fuel gas and converts combustion energy of the fuel gas into rotational energy of a crank shaft 41a. In the present embodiment, the internal combustion engine 41 is a hydrogen engine that can use the hydrogen gas as the fuel. The internal combustion engine 41 is, for example, a multiple cylinder engine.

The internal combustion engine 41 includes throttle equipment 41b, an igniter 41c, and a fuel supplier 41d. The throttle equipment 41b adjusts an intake air amount of the internal combustion engine 41. For example, the throttle equipment 41b is electronic control throttle equipment that makes a throttle valve perform opening/closing operations by a motor. The igniter 41c ignites a fuel-air mixture in a combustion chamber of the internal combustion engine 41. The igniter 41c is, for example, an ignition plug. The fuel supplier 41d supplies the fuel to a combustion chamber of the internal combustion engine 41.

One end portion of the fuel pipe 42 is connected to the fuel supplier 41d of the internal combustion engine 41. The other end portion of the fuel pipe 42 includes a fuel receiving port 42a. The fuel receiving port 42a of the electric power generating unit 40 and the supply port 23d of the fuel supply unit 20 are connected to each other by a connection pipe 15. The connection pipe 15 is supported by, for example, the carbody 2. The hydrogen gas is guided from the fuel supply unit 20 through the connection pipe 15 and the fuel pipe 42 to the fuel supplier 41d of the internal combustion engine 41.

The electric power generator 43 generates electric power by rotational power of the internal combustion engine 41. The electric power generator 43 includes a rotating shaft 43a that is coupled to the crank shaft 41a so as to rotate together with the crank shaft 41a. A rotor is located at the rotating shaft 43a, and a stator is located at a position opposed to the rotor. The electric power generator 43 is, for example, a three-phase induction motor.

The inverter 44 is electrically connected to the electric power generator 43. The inverter 44 converts AC power, generated by the electric power generator 43, into DC power. The inverter 44 may also be called a converter. Moreover, the inverter 44 is electrically connected to the electric interface 45. The electric interface 45 electrically connects the inverter 44 of the electric power generating unit 40 to the electric power storing body 13 located outside the electric power generating unit 40. In the case of contact power supply, the electric interface 45 is a detachable terminal or a detachable electric power connector. In the case of non-contact power supply, the electric interface 45 is a coil.

The communication interface 46 connects the electric power ECU 47 to the integrator 60, located outside the electric power generating unit 40, such that the electric power ECU 47 is communicable with the integrator 60. In the case of wired communication, the communication interface 46 is a detachable terminal or a detachable communication connector. In the case of wireless communication, the communication interface 46 is a known wireless communicator.

The electric power ECU 47 controls the internal combustion engine 41, the inverter 44, and the like that are control targets in each electric power generating unit 40. Hereinafter, the control targets in each electric power generating unit 40 are referred to as “unit control targets X.” The electric power ECU 47 controls the unit control targets X based on signals received from the integrator 60 through the communication interface 46. The unit control targets X include the throttle equipment 41b, the igniter 41c, the fuel supplier 41d, and the inverter 44 in the internal combustion engine 41. The unit control targets X may include the informer 49, an oil control valve unit 54, and the like which will be described later.

The electric power ECU 47 includes a processor, a system memory, and a storage memory. The processor includes, for example, a central processing unit (CPU). The system memory is, for example, a RAM. The storage memory may include a ROM. The storage memory may include a hard disk, a flash memory, or a combination thereof. The storage memory stores a program. The electric power ECU 47 is one example of the unit control circuitry.

Moreover, the electric power ECU 47 communicates with the integrator 60 through the communication interface 46. Specifically, the electric power ECU 47 associates state information with unit identification information (unit ID) and transmits the state information and the unit identification information to the integrator 60 through the communication interface 46. The state information indicates a state of the electric power generating unit 40, and the unit identification information (unit ID) is information for identifying the electric power generating unit 40.

The state information includes information regarding damage over time. Moreover, the state information may include a past driving history. For example, the state information may include information regarding a rotational frequency of the internal combustion engine 41, generated torque of the internal combustion engine 41, the driving history of the internal combustion engine 41, the electric power generation amount of the electric power generator 43, impact force applied to the electric power generating unit 40 from an outside, or the lives of the components of the electric power generating unit 40.

Moreover, the electric power ECU 47 receives an electric power generation command from the integrator 60 through the communication interface 46. Details of the electric power generation command will be described later.

The informer 49 is electrically connected to the electric power ECU 47. The informer 49 informs of the state of the electric power generating unit 40. The informer 49 includes, for example, a display or a light emitter. For example, the display is a liquid crystal display. For example, the light emitter is a LED. The informer 49 informs of, for example, maintenance information related to the maintenance of the electric power generating unit 40. The maintenance information is, for example, information indicating the necessity of the replacement, repair, or inspection of the electric power generating unit 40 or the component included in the electric power generating unit 40 or the timing of the replacement, repair, or inspection of the electric power generating unit 40 or the component included in the electric power generating unit 40. The maintenance information is one example of management support information.

Moreover, the electric power generating unit 40 includes an oil pump 51, a lubricating oil passage 52, a drive oil passage 53, the oil control valve unit 54, and an oil port 55.

The oil pump 51 is driven in mechanical association with the rotation of the crank shaft 41a. Oil is pumped up from an oil pan of the internal combustion engine 41 by the oil pump 51, and the lubricating oil passage 52 guides this oil as lubricating oil to respective places, such as a gear of the internal combustion engine 41.

The drive oil passage 53 extends from the lubricating oil passage 52. One end portion of the drive oil passage 53 is connected to the lubricating oil passage 52. Moreover, the other end portion of the drive oil passage 53 is connected to the oil port 55.

The oil port 55 is a fluid interface that outputs the oil to a hydraulic actuator 16 located outside the electric power generating unit 40. An oil pipe 17 is detachably connected to the oil port 55 and is connected to an inflow port of the hydraulic actuator 16 mounted on the carbody 2. The hydraulic actuator 16 is, for example, a hydraulic cylinder that generates braking force.

The oil control valve unit 54 is located at the drive oil passage 53. The oil control valve unit 54 serves as fluid control equipment that opens and closes the drive oil passage 53 to control hydraulic pressure applied to the hydraulic actuator 16.

The drive oil passage 53 does not have to extend from the lubricating oil passage 52. For example, the drive oil passage 53 may be supplied with the oil from an oil pump different from the oil pump 51 for lubrication.

Moreover, the electric power generating unit 40 includes a circulator that circulates a circulating liquid in at least the internal combustion engine 41. The circulator includes a cooling medium pump 56, a cooling channel 57, and a radiator 58. The cooling medium pump 56 discharges a cooling medium (water, for example). The cooling medium pump 56 is driven in mechanical association with the rotation of the crank shaft 41a. However, the cooling medium pump 56 may be driven by another power source.

The cooling channel 57 is a circulation channel through which the cooling medium discharged from the cooling medium pump 56 is guided to, for example, the internal combustion engine 41, and the cooling medium (corresponding to the circulating liquid) which has cooled the internal combustion engine 41 returns to the cooling medium pump 56. The cooling channel 57 may guide the cooling medium to the electric power generator 43 and the inverter 44 to cool the electric power generator 43 and the inverter 44. The radiator 58 is located at the cooling channel 57 and radiates the heat of the cooling medium circulating in the cooling channel 57.

The electric power generating unit 40 includes a support structural body 48. The components 44, 45, 46, 47, 49, 51, 52, 53, 54, 55, 56, 57, and 58 included in the electric power generating unit 40 except for the support structural body 48 are supported by the support structural body 48 and are combined as a unit. The components 44, 45, 46, 47, 49, 51, 52, 53, 54, 55, 56, 57, and 58 (except for the support structural body 48) included in the electric power generating unit 40 are directly or indirectly connected and fixed to the support structural body 48.

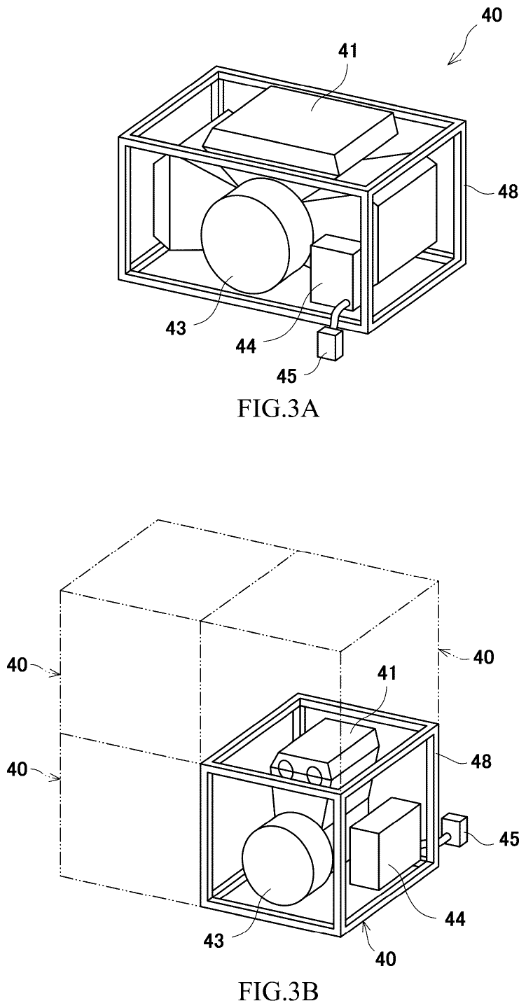

FIG. 3A is a schematic perspective view showing the electric power generating unit 40 including the internal combustion engine 41 of a horizontally opposed type, as one example of the electric power generating unit 40. FIG. 3B is a schematic perspective view showing the electric power generating unit 40 including the internal combustion engine 41 of an in-line type, as another example of the electric power generating unit 40. In FIGS. 3A and 3B, only the internal combustion engine 41, the electric power generator 43, the inverter 44, and the electric interface 45 are shown among the components of the electric power generating unit 40 which are supported by the support structural body 48, and the other components are not shown.

As shown in FIG. 3, in the present embodiment, the support structural body 48 includes frames. The frames of the support structural body 48 are coupled to each other so as to surround the components 44, 45, 46, 47, 49, 51, 52, 53, 54, 55, 56, 57, and 58 of the electric power generating unit 40. For example, the support structural body 48 includes: upper-lower frames extending in an upper-lower direction; and horizontal frames connected to the upper-lower frames and extending in a horizontal direction. For example, the support structural body 48 includes a plate on which the internal combustion engine 41 is placed. For example, the support structural body 48 may have a structure that supports the components, such as the internal combustion engine 41 and the electric power generator 43, of the electric power generating unit 40 from below or may have a structure that supports those from above (i.e., a structure that supports those by suspending them).

In the railcar 1 of the present embodiment, the support structural bodies 48 are not located so as to be lined up in the upper-lower direction. However, as shown by two-dot chain lines in FIG. 3B, the support structural bodies 48 can be stacked on each other in the upper-lower direction. When the support structural bodies 48 are stacked on each other in the upper-lower direction, attaching positions of the support structural bodies 48 with respect to the movable body can be reduced. Moreover, the support structural bodies 48 may be coupleable to each other in the horizontal direction. To be specific, the support structural bodies 48 may be located so as to be lined up in at least one of the front-rear direction or the left-right direction. In this case, when attaching or detaching one electric power generating unit 40, it is unnecessary to detach the other electric power generating units 40 from the movable body, unlike a case where the electric power generating units 40 are located in the upper-lower direction.

The support structural body 48 is attachable to and detachable from the carbody 2 while keeping supporting both of the internal combustion engine 41 and the electric power generator 43. To be specific, the electric power generating unit 40 is detachably mounted on the carbody 2. The electric power generating unit 40 is replaceable with another electric power generating unit 40 having the same structure. Moreover, the support structural bodies 48 mounted on the carbody 2 are common in structure to each other. For example, the dimensions of the support structural bodies 48 in the upper-lower direction, the left-right direction, and the front-rear direction are the same as each other. Therefore, one electric power generating unit 40 mounted on the carbody 2 is replaceable with another electric power generating unit 40 having the same structure.

Moreover, the electric power generating unit 40 includes at least one sensor 59 that detects the state of the electric power generating unit 40. Information detected by the at least one sensor 59 is transmitted to the electric power ECU 47.

In other words, the state of the electric power generating unit 40 includes at least one of the states of the components 44, 45, 46, 47, 49, 51, 52, 53, 54, 55, 56, 57, and 58 included in the electric power generating unit 40. For simplicity, in FIG. 2, the at least one sensor 59 is shown by one block. Moreover, the at least one sensor 59 may include a sensor that constitutes part of the component 44, 45, 46, 47, 49, 51, 52, 53, 54, 55, 56, 57, or 58 of the electric power generating unit 40.

For example, the at least one sensor 59 may include: a temperature sensor that detects an oil temperature; a temperature sensor that detects the temperature of cooling water; a temperature sensor that detects the temperature of the electric power generator 43; a temperature sensor that detects the temperature of the inverter 44; a current sensor included in the inverter 44; a rotational frequency sensor that detects the rotational frequency (rotational speed) of the internal combustion engine 41; a throttle opening degree sensor; a strain gauge that detects mechanical loads of machine parts and structural bodies included in the electric power generating unit 40; and a flow rate sensor that detects the flow rate of the fuel flowing in the fuel pipe 42.

### Configuration of Integrator

Referring back to FIG. 2, the integrator 60 receives information from the electric power generating units 40 and the fuel supply unit 20. The integrator 60 includes a communication interface 61, integration control circuitry 62, and a display 63. The integration control circuitry 62 is also called an integration ECU (Electronic Control Unit) 62.

The communication interface 61 connects the integration ECU 62 to the car control circuitry 7, the electric power generating unit 40, and the fuel supply unit 20 such that the integration ECU 62 is communicable with the car control circuitry 7, the electric power generating unit 40, and the fuel supply unit 20. In the case of wired communication, the communication interface 61 is a detachable terminal or a detachable communication connector. In the case of wireless communication, the communication interface 61 is a known wireless communicator.

The integration ECU 62 communicates with all of the electric power generating units 40 and the fuel supply unit 20 which are mounted on the railcar 1. The integration ECU 62 includes a processor, a system memory, and a storage memory. The processor includes, for example, a central processing unit (CPU). The system memory is, for example, a RAM. The storage memory may include a ROM. The storage memory may include a hard disk, a flash memory, or a combination thereof. The storage memory stores a program.

The integration ECU 62 associates the state information and the unit identification information, which are received from the electric power generating units 40 and the fuel supply unit 20, with each other and stores the state information and the unit identification information in the memory.

The display 63 is electrically connected to the integration ECU 62. The display 63 outputs, for example, maintenance information related to the maintenance of each electric power generating unit 40.

### Control of Movable Body

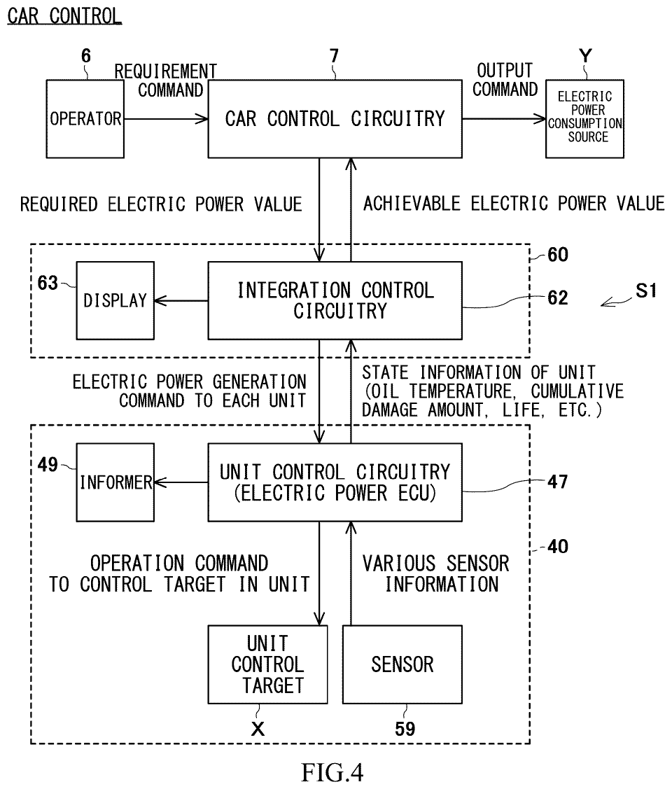

Next, one example of the control of the drive system during the traveling of the railcar 1 will be described with reference to FIGS. 4 to 7.

FIG. 4 is a block diagram showing the flow of communication information of the components in the drive system shown in FIG. 2. The requirement command is transmitted from the operator 6 to the car control circuitry 7 in accordance with an operation input of the driver with respect to the operator 6.

The car control circuitry 7 generates an output command based on the requirement command received from the operator 6 and transmits the output command to the inverter 14 or the like to control the inverter 14 or the like. Thus, the rotational driving force generated by the electric motor 11 is controlled. Electric power consumption sources, such as electric components and the electric motor 11 in the carbody 2, to which the electric power is supplied from the electric power generating units 40 are referred to as electric power consumption sources Y.

The car control circuitry 7 acquires electric power consumption information indicating an electric power consumption state of the electric power consumption source Y. The car control circuitry 7 may calculate the electric power consumption information based on information received from various sensors (such as the current sensor included in the inverter 14) mounted on the carbody 2 or may receive the electric power consumption information from other equipment.

Moreover, the car control circuitry 7 requests, for example, the electric power required by the electric power consumption source Y, from the unit management system S1. Specifically, as shown in FIG. 4, the car control circuitry 7 receives information indicating an achievable electric power value, from the integration ECU 62. The car control circuitry 7 requests an electric power value which is the received achievable electric power value or less, from the integration ECU 62. The car control circuitry 7 transmits to the integration ECU 62 the electric power consumption information indicating the electric power consumed by the electric power consumption source Y. In other words, based on the requirement command received from the operator 6, the car control circuitry 7 transmits required electric power information as the electric power consumption information to the integration ECU 62. The required electric power information indicates a required electric power value required to satisfy the requirement command. For example, the required electric power value is an electric power value required by the electric motor 11 to satisfy the requirement command.

The integration ECU 62 receives the required electric power information (electric power consumption information) from the car control circuitry 7. Moreover, the integration ECU 62 receives the state information from each electric power generating unit 40. The integrator 60 transmits the electric power generation command as an operation command to each electric power generating unit 40 based on the state information and the required electric power information (electric power consumption information). The electric power generation command includes a required electric power generation amount that is required of the electric power generating unit 40. The integration ECU 62 determines the required electric power generation amount, which is to be transmitted to each electric power generating unit 40, based on the state information and the required electric power information (electric power consumption information). Each electric power ECU 47 receives the electric power generation command from the integration ECU 62 and controls the unit control target X based on the required electric power generation amount determined by the integration ECU 62.

In the present embodiment, the electric power generation amounts that are required of the four electric power generating units 40 may be different from each other. Moreover, the electric power generation command may also include a stop command that instructs the stop of the electric power generation. For example, the integration ECU 62 may not transmit the electric power generation command to at least one of the four electric power generating units 40 or may transmit the stop command of the electric power generation to at least one of the four electric power generating units 40. The integration ECU 62 may comprehensively consider the state, maintenance information, electric power generation efficiency, and the like of each electric power generating unit 40 to change the content of the electric power generation command for each electric power generating unit 40. For example, when the total electric power generation amount which can be generated by the four electric power generating units 40 is larger than the supply electric power necessary to move the movable body, the integration ECU 62 may transmit the stop command to at least one electric power generating unit 40.

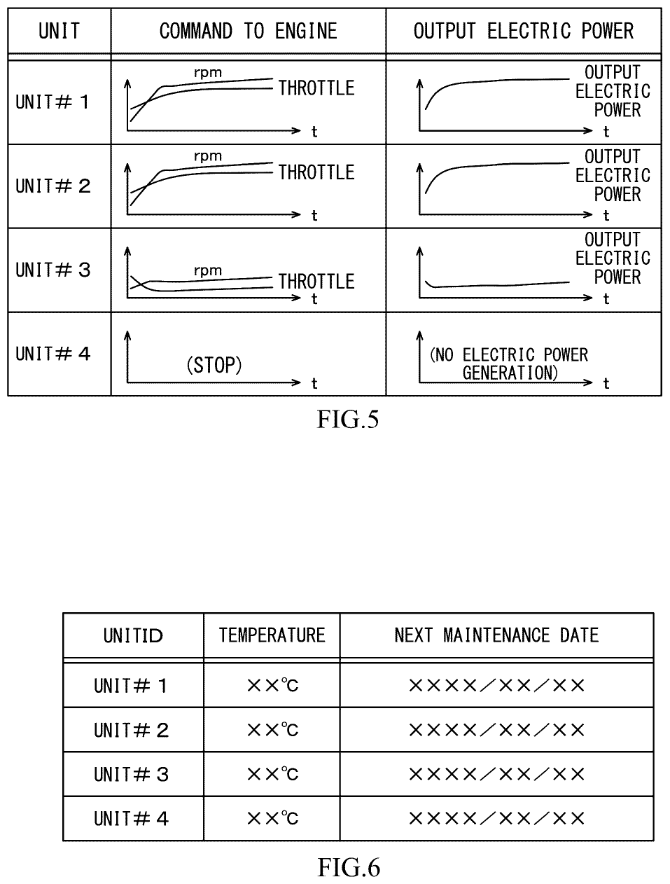

FIG. 5 is a diagram for explaining an example in which the contents of the electric power generation commands transmitted to the four electric power generating units 40 are different from each other. Specifically, FIG. 5 is a table showing one example including the contents of the electric power generation commands transmitted to the internal combustion engines 41 of the four electric power generating units 40 and the output electric powers corresponding to the electric power generation commands. Hereinafter, the four electric power generating units 40 may be referred to as a “unit #1,” a “unit #2,” a “unit #3,” and a “unit #4.” Each of the electric power generation commands transmitted to the internal combustion engines 41 and the output electric powers is shown by a graph. More specifically, in FIG. 5, as an operation command transmitted to the internal combustion engine 41, a temporal transition of the engine rotational frequency and a temporal transition of the throttle opening degree are shown by a graph.

Since the unit #1 and the unit #2 receive the respective electric power generation commands indicating the electric power generation amounts that are the same as each other, as shown in FIG. 5, the output electric power of the unit #2 is the same as the output electric power of the unit #1. Since the unit #3 receives the electric power generation command indicating the smaller electric power generation amount than the unit #1 and the unit #2, the output electric power of the unit #3 is a value smaller than the output electric power of the unit #1. Moreover, since the unit #4 receives the stop command from the integration ECU 62, the unit #4 does not generate the electric power.

In the present embodiment, total electric power generated by the electric power generating units 40, the number of which is smaller than the number of all electric power generating units 40 by one, is set larger than the electric power necessary to advance the movable body 1. Therefore, even when there is an abnormality in one of the electric power generating units 40, the movable body 1 can continuously advance by the supply of the electric power from the other electric power generating units 40. Moreover, advancing power against resistance power is enough when the movable body 1 travels at a constant speed, unlike when the movable body 1 starts traveling. Therefore, the supply electric power generated by the four electric power generating unit 40 when the movable body 1 travels at a constant speed may be set smaller than that when the movable body 1 starts traveling. In this case, the number of electric power generating units 40 that perform the electric power generation may be controlled instead of setting reducing widths of the generated electric powers of the electric power generating units 40 during the constant-speed traveling from the generated electric powers of the electric power generating units 40 at the time of the start to be equal to each other. In this case, the electric power generating units 40 are made to generate electric power in an operating region where the power generation efficiency with respect to unit fuel consumption is high, and thus, the electric power is appropriately obtained as a whole. Therefore, the power generation efficiency can be improved more than when all the electric power generating units 40 are made to generate electric power while setting the reducing widths of the generated electric powers to be equal to each other.

Example 1 in which the contents of the electric power generation commands for the respective units are made different from each other

An example in which the contents of the electric power generation commands for the respective electric power generating units 40 are made different from each other based on the states or maintenance information of the electric power generating units 40 will be described with reference to FIG. 6. FIG. 6 is a table showing the unit identification information, temperature information corresponding to the unit identification information, and the maintenance information corresponding to the unit identification information. For example, the temperature information is information indicating the temperature detected by the sensor 59 in the electric power generating unit 40. The temperature may be the temperature of the lubricating oil for the internal combustion engine 41 or the like, the temperature of the cooling water for cooling the internal combustion engine 41 or the like, the temperature of the electric power generator 43, or the temperature of the inverter 44.

The integration ECU 62 receives the temperature information from each electric power generating unit 40 as one type of state information. To be specific, the electric power ECU 47 associates the state information (including the temperature information) indicating the state of the electric power generating unit 40 with the unit identification information (unit ID) for identifying the electric power generating unit 40 and transmits the state information and the unit identification information to the integration ECU 62 through the communication interface 46. The integration ECU 62 associates the state information indicating the state of the electric power generating unit 40 with the unit identification information and stores the state information and the unit identification information in the memory.

For example, based on the pieces of state information from the units #1, #2, #3, and #4 that are the four electric power generating units 40, the integration ECU 62 determines respective electric power amounts that are required of the four electric power generating units 40. Basically, the sum of the electric power amounts that are required of the four electric power generating units 40 coincides with the required electric power value received from the car control circuitry 7.

For example, the integration ECU 62 determines whether or not the temperature corresponding to each electric power generating unit 40 exceeds a predetermined threshold. For example, when the integration ECU 62 determines that the temperature corresponding to the unit #4 exceeds the predetermined threshold, to suppress damages (i.e., temperature loads) of the components (such as the internal combustion engine 41) included in the unit #4, the integration ECU 62 transmits the stop command to the unit #4 or transmits to the unit #4 the electric power generation command indicating the electric power generation amount that is smaller than the electric power generation amount that is required of each of the units #1, #2, and #3 that are the other electric power generating units 40.

When the integration ECU 62 determines that the movable body 1 is in a state where the required electric power value is large, such as a start state, an upward slope traveling state, a large load amount state, or a towing state, the integration ECU 62 increases the number of electric power generating units 40 that generate the electric power or increases the electric power generated by each electric power generating unit 40. On the other hand, when the movable body 1 is in a state where the required electric power value is small, such as an inertial traveling state or a downward slope traveling state, the integration ECU 62 may instruct at least one of the electric power generating units 40 to generate the electric power in an operating region where the power generation efficiency is high, and may also instruct the other electric power generating units 40 to stop generating the electric power or suppress the output of the electric power.

As described above, when the electric power that can be generated is larger than the required electric power, the integration ECU 62 may reduce the output of the electric power generating unit 40 which has an abnormality or which highly possibly causes an abnormality since the opportunity of the maintenance and inspection is close. Moreover, the integration ECU 62 may sequentially switch the electric power generating units 40, which stop generating the electric power or whose outputs are suppressed, for every predetermined period of time in order to prevent operation opportunities of the electric power generating units 40 from becoming unbalanced. Furthermore, by accumulating information regarding identification numbers and abnormal states, the tendency of the occurrence of the abnormal state and the like can be easily grasped, and therefore, maintenance and replacement frequencies are easily optimized.

Moreover, as shown in FIG. 6, the integration ECU 62 associates the maintenance information of the electric power generating unit 40 with the unit identification information of the electric power generating unit 40 and stores the maintenance information and the unit identification information. For example, the maintenance information may be information received by the integration ECU 62 from each electric power generating unit 40 or may be information received by the integration ECU 62 from an outside of the railcar 1. As one example of the maintenance information, FIG. 6 shows information indicating a next maintenance date of the electric power generating unit 40. In the present embodiment, the next maintenance date of the electric power generating unit 40 is a timing at which the electric power generating unit 40 is replaced with another electric power generating unit 40 which has already been subjected to the maintenance.

For example, the integration ECU 62 may determine the electric power generation command of the electric power generating unit 40 whose next maintenance date is close such that an overload on this electric power generating unit 40 is permitted. For example, the integration ECU 62 may determine the electric power generation command of the electric power generating unit 40 whose next maintenance date is close such that this electric power generating unit 40 continuously generates the electric power even when the temperature exceeds the predetermined threshold.

Example 2 in which the contents of the electric power generation commands for the respective units are made different from each other

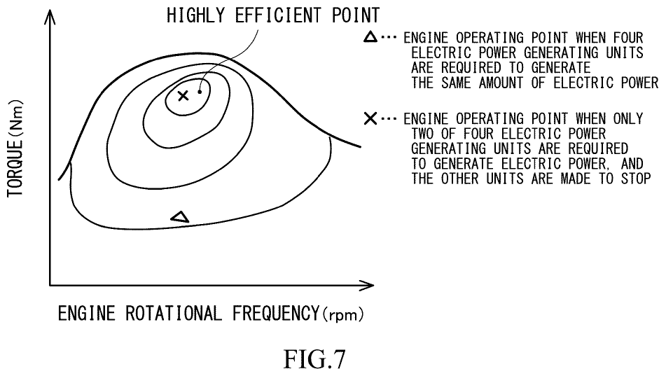

An example in which the contents of the electric power generation commands for the respective electric power generating units 40 are made different from each other from the viewpoint of the electric power generation efficiency will be described with reference to FIG. 7. FIG. 7 shows one example of an efficiency map of the internal combustion engine 41. The efficiency map shown in FIG. 7 is a fuel consumption rate map. In FIG. 7, a horizontal axis represents an engine rotational frequency, and a vertical axis represents engine torque. In FIG. 7, the fuel consumption rate of the internal combustion engine 41 is shown by contour lines. A graph shown by a thick line in FIG. 7 is an engine performance curve indicating maximum torque of the internal combustion engine 41.

The efficiency deteriorates in a direction away from a highly efficient point in FIG. 7. Therefore, from the viewpoint of the fuel consumption rate, it is desirable that the internal combustion engine 41 of the electric power generating unit 40 be made to operate in a region that is as close to the highly efficient point as possible.

For example, it is assumed that when each of the units #1, #2, #3, and #4 that are the four electric power generating units 40 is instructed to generate electric power corresponding to one fourth of the required electric power value transmitted from the car control circuitry 7, an operating point of the internal combustion engine 41 of each electric power generating unit 40 is a point shown by a triangle in FIG. 7. It is understood that since this operating point is relatively far from the highly efficient point, the operating point is inefficient. In this case, each of only two of the four units #1, #2, #3, and #4 is instructed to generate electric power corresponding to one half of the required electric power value transmitted from the car control circuitry 7, and the other two units are made to stop. Thus, the engine operating point becomes a point which is shown by x in FIG. 7 and close to the highly efficient point, and this improves the fuel efficiency.

As above, the integration ECU 62 may determine the electric power generation amount that is required of each electric power generating unit 40, from the engine efficiency map stored in the memory. Moreover, although FIG. 7 shows the engine efficiency map, the integration ECU 62 may determine the electric power generation amount that is required of each electric power generating unit 40, from a motor efficiency map of the electric power generator 43. Moreover, for example, the integration ECU 62 may store in the memory at least one of the efficiency map of the internal combustion engine 41 of the electric power generating unit 40 or the efficiency map of the electric power generator 43 of the electric power generating unit 40. Then, based on at least one efficiency map and the required electric power information received from the car control circuitry 7, the integration ECU 62 may determine the number of electric power generating units 40 to which the electric power generation commands are to be transmitted. In other words, based on the required electric power information received from the car control circuitry 7, the integration ECU 62 may determine the electric power generating unit 40 that is to be stopped. Based on the state information received from each electric power generating unit 40, the integration ECU 62 may determine the electric power generating unit 40 whose electric power generation is to be stopped.

### Informing of Maintenance Information

Moreover, the integrator 60 transmits the electric power generation commands to the electric power generating units 40, and in addition, collects and outputs the maintenance information related to the maintenance of the electric power generating units 40. In the present embodiment, the integrator 60 periodically or non-periodically receives the state information from each electric power generating unit 40 and displays on the display 63 the maintenance information related to the maintenance of the electric power generating unit 40 based on the received state information of the electric power generating unit 40. Specifically, the integration ECU 62 determines the necessity of the maintenance of each electric power generating unit 40 based on the state information received from the electric power generating unit 40. The integration ECU 62 displays the determined necessity of the maintenance as the maintenance information on the display 63. A company that manages the movable body 1 can see the display 63 to grasp, for example, the electric power generating unit 40 that requires the maintenance, the timing of the maintenance, and the like.

Moreover, in the present embodiment, the integration ECU 62 transmits a determination result of the necessity of the maintenance of each electric power generating unit 40 to the electric power generating unit 40. The electric power ECU 47 makes the informer 49 inform of the received determination result as the maintenance information. For example, when the informer 49 is the light emitter, the electric power ECU 47 of the electric power generating unit 40 that requires the maintenance makes the informer 49 emit light such that the necessity of the maintenance is visually confirmable. Thus, a maintenance worker can easily find the electric power generating unit 40 that requires the maintenance among the electric power generating units 40.

### Maintenance Method

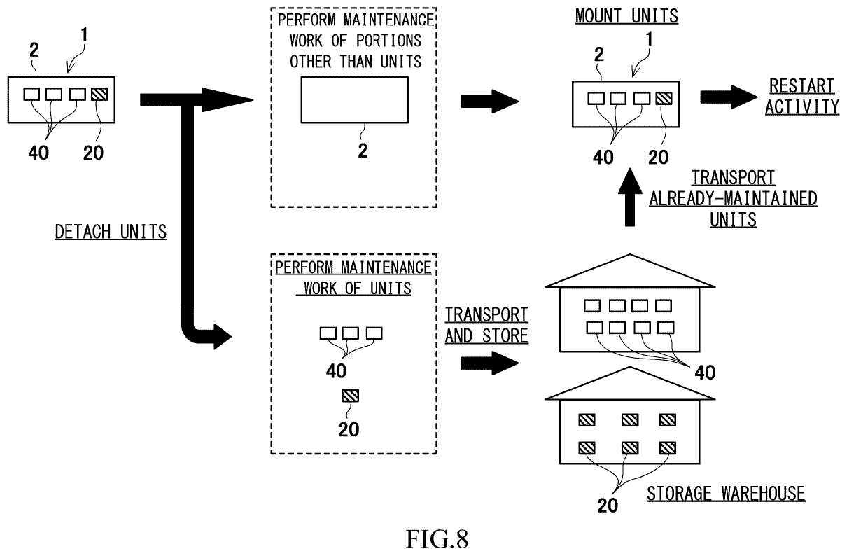

Next, a maintenance method of the railcar 1 that is the movable body will be described with reference to FIG. 8. For example, the maintenance of the railcar 1 is periodically performed or is performed when there is an abnormality in the component included in the railcar 1. FIG. 8 shows the flow of the maintenance method of the railcar 1. Hereinafter, the electric power generating unit 40 and the fuel supply unit 20 are simply referred to as the unit 20 and the unit 40, respectively.

The railcar 1 includes maintenance targets, and the maintenance targets include the units 20 and 40. In the present embodiment, among the maintenance targets of the railcar 1, the units 20 and 40 and the other maintenance targets are separately subjected to the maintenance.

Specifically, before starting the maintenance work of the railcar 1, the railcar 1 is transported to a maintenance work place, and then, all the units 20 and 40 are detached from the carbody 2. All the units 20 and 40 which are detached for the maintenance from the carbody 2 may also be called not-yet-maintained units. After all the units 20 and 40 are detached, the maintenance work of the maintenance targets other than the units 20 and 40 is started.

The maintenance work of the units 20 and 40 which have been detached from the carbody 2 is also started. Hereinafter, the units 20 and 40 which have been detached from the carbody 2 are referred to as old units 20 and 40. After the maintenance work of the old units 20 and 40 is completed, the old units 20 and 40 are stored in, for example, a storage warehouse. The storage warehouse stores already-maintained units 20 and 40. Hereinafter, the already-maintained units 20 and 40 are referred to as new units. The new units 20 and 40 stored in the storage warehouse are the same in structure as the old units 20 and 40. To be specific, the storage warehouse stores the units 20 and 40 for replacement.

Regardless of whether or not the maintenance of the old units 20 and 40 which have been detached from the railcar 1 has been completed, the already-maintained units 20 and 40 different form the old units 20 and 40 are mounted on the railcar 1. To be specific, before the maintenance work of the old units 20 and 40 is completed, the new units 20 and 40 are transported from the storage warehouse to the maintenance work place for the railcar 1, and then, the new units 20 and 40 are mounted on the railcar 1.

Therefore, when the maintenance work of the portions of the railcar 1 other than the old units 20 and 40 and the work of attaching the new units 20 and 40 to the railcar 1 are completed, the maintenance work of the railcar 1 is completed regardless of whether or not the maintenance of the old units 20 and 40 is completed, and the railcar 1 can restart its activity. To be specific, the railcar 1 can restart its activity without waiting for the completion of the maintenance work of the old units 20 and 40. After the maintenance work of the old units 20 and 40 is completed, these units 20 and 40 are stored in the storage warehouse as the already-maintained units.

### Effects

In the present embodiment, as the drive system of the movable body 1, electric power generating sources are distributedly located by using the electric power generating units 40. Therefore, as compared to when a single power source is used, the stop of the supply of the electric power is prevented, and the operation of the movable body 1 is easily continued. Moreover, the integrator 60 grasps the states of the electric power generating units 40. Therefore, even when the electric power generating units 40 are used, the electric power generating units 40 can be easily managed such that the total output electric power and the states of the units become appropriate.

Moreover, in the present embodiment, the integrator 60 transmits the operation commands of the electric power generating units 40 to the electric power generating units 40 based on the received state information of the electric power generating units 40. Therefore, the operations of the electric power generating units 40 are easily and individually optimized.

Moreover, in the present embodiment, the integrator 60 includes the display 63 that displays the maintenance information related to the maintenance of the electric power generating units 40 based on the received state information of the electric power generating units 40. Therefore, the maintenance of each electric power generating unit 40 is easily optimized.

Moreover, in the present embodiment, the electric power generating unit 40 includes the informer 49 that informs of the maintenance information related to the maintenance of the electric power generating unit 40. Therefore, even when the electric power generating units 40 that are the same in shape as each other are located, the electric power generating unit 40 that requires the maintenance is easily grasped.

Moreover, in the present embodiment, the integrator 60 periodically or non-periodically receives the state information from each electric power generating unit 40 and determines the necessity of the maintenance of the electric power generating unit 40 based on the received state information of the electric power generating unit 40. Therefore, before the electric power generating unit 40 becomes abnormal (stops its output), the replacement of the electric power generating unit 40 is urged. Thus, the activity of the movable body 1 is easily continued.

Moreover, in the present embodiment, since the electric power generating units 40 are the same in structure as each other, the electric power generating unit 40 is easily replaced. Furthermore, maintenance parts of the electric power generating units 40 are easily made common to each other.

Moreover, in the present embodiment, the integrator 60 receives the electric power consumption information indicating the electric power consumed by the electric power consumption source that is supplied with the electric power from the electric power generating units 40, and based on the state information and the electric power consumption information, the integrator 60 transmits the operation command to each electric power generating unit 40. Therefore, the operations of the electric power generating units 40 are easily and individually optimized in accordance with the electric power consumption state of the electric power consumption source.

Moreover, in the present embodiment, the integrator 60 that manages the states of the electric power generating units 40 also controls the electric power generating units 40 based on the state information of the electric power generating units 40. Therefore, the control corresponding to the states of the electric power generating units 40 can be realized.

Moreover, in the present embodiment, the internal combustion engine 41 can use the hydrogen gas as the fuel. Therefore, a purifier that purifies substances contained in an exhaust gas can be reduced in size, and the cost for the purifiers when the electric power generating units 40 are located can be reduced. Moreover, even when the purifier is located at the electric power generating unit 40, the replacement frequency of the purifier due to deterioration can be reduced.

Moreover, in the present embodiment, the state information includes information regarding damage over time. Therefore, the abnormalities, lives, and the like of the components of the electric power generating unit 40 can be recognized from the state information.

### Embodiment 2

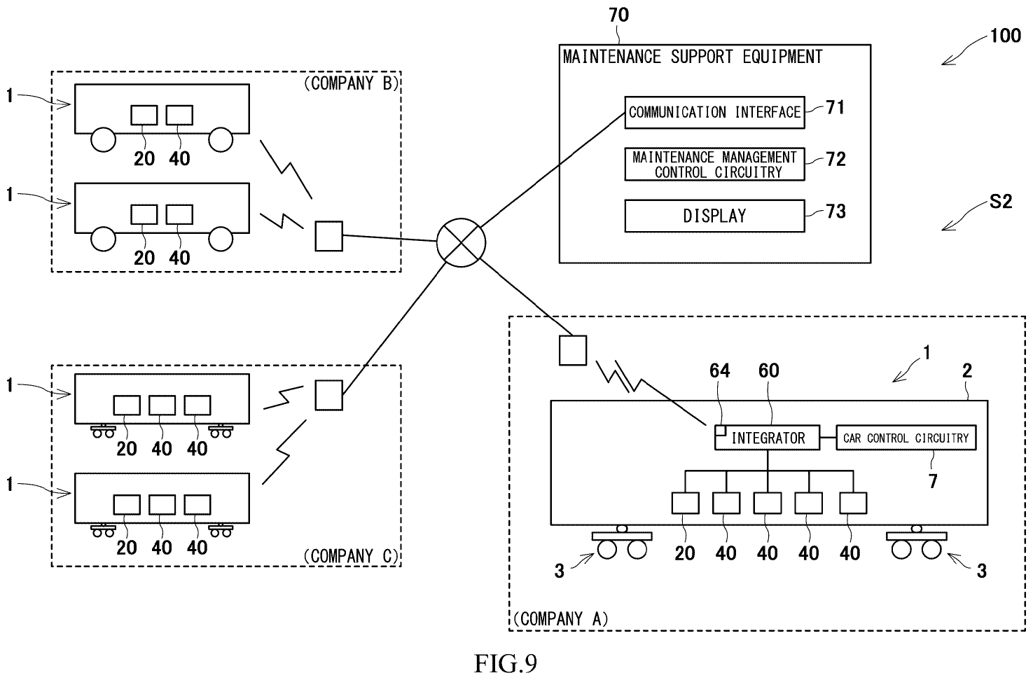

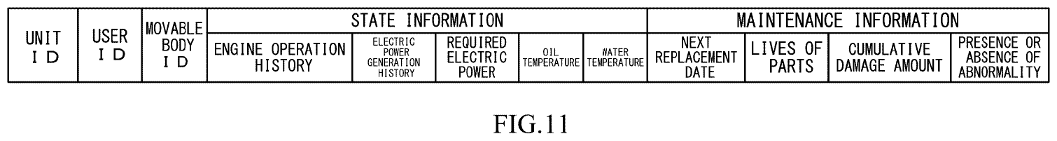

Next, a unit management system S2 according to Embodiment 2 will be described with reference to FIGS. 9 and 11. In Embodiment 2, the same reference signs are used for the same components as Embodiment 1, and explanations thereof are omitted.

FIG. 9 is a schematic configuration diagram of a maintenance management system 100 including the unit management system S2 according to Embodiment 2. In addition to the electric power generating units 40, the fuel supply units 20, and the integrators 60 which are mounted on the movable bodies 1, the unit management system S2 of the present embodiment further includes maintenance support equipment 70 located outside the movable bodies 1. In the present embodiment, a combination of the integrators 60 and the maintenance support equipment 70 is one example of the management support equipment.

The maintenance management system 100 is a system that maintains and manages the electric power generating units 40 and the fuel supply units 20 which are mounted on the movable bodies 1. The maintenance management system 100 allows a maintenance management company, instead of a company or user who operates the movable body 1, to perform the maintenance and management of the electric power generating units 40 and the fuel supply units 20 which are mounted on the movable bodies 1. For example, the movable bodies 1 are owned by various companies and individual users. For example, the type of the movable body 1 does not have to be the railcar described in Embodiment 1 and may be another type of movable body, such as a bus, a ship, or a utility vehicle.

The maintenance support equipment 70 is used by, for example, the maintenance management company. The maintenance support equipment 70 includes a communication interface 71, maintenance support control circuitry 72, and a display 73.

The communication interface 71 communicably connects the maintenance support control circuitry 72 to the integrators 60 through a communication network, such as the Internet or a LAN. In the present embodiment, the integrator 60 and the maintenance support equipment 70 communicate with each other through a relay 80. Specifically, the integrator 60 includes a wireless communicator 64 that wirelessly communicates with the relay 80. The relay 80 is connected to the Internet and is communicable with the maintenance support equipment 70 through the Internet. However, the communication interface 71 may be a wireless communicator by which the maintenance support equipment 70 can perform direct wireless communication with the integrator 60.

The maintenance support control circuitry 72 includes a processor, a system memory, and a storage memory. The processor includes, for example, a central processing unit (CPU). The system memory is, for example, a RAM. The storage memory may include a ROM. The storage memory may include a hard disk, a flash memory, or a combination thereof. The storage memory stores a program.

The display 73 is electrically connected to the maintenance support control circuitry 72. The display 73 outputs, for example, the maintenance information of each electric power generating unit 40.

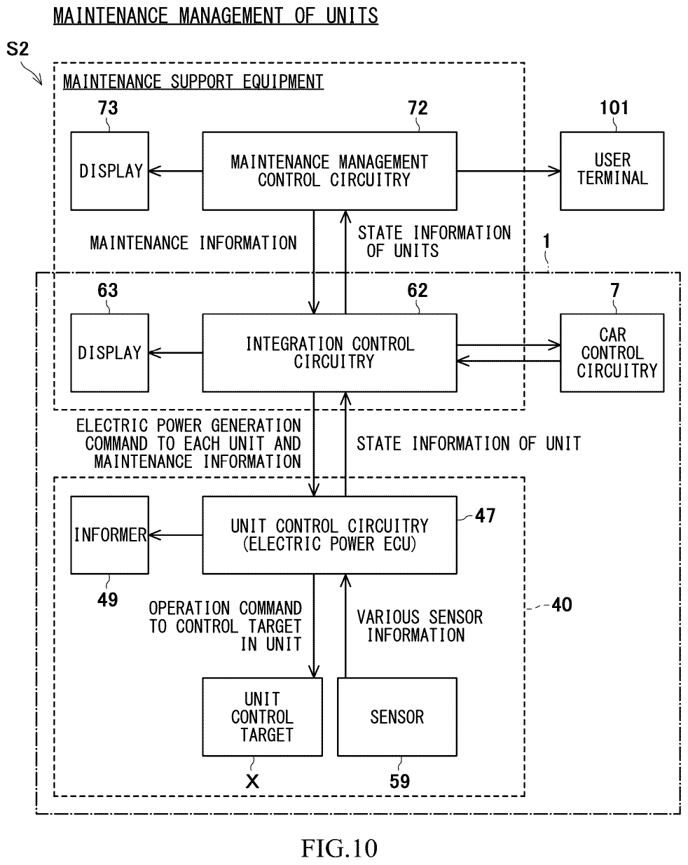

FIG. 10 is a block diagram showing the flow of the information in the unit management system S2 shown in FIG. 9. In the present embodiment, the maintenance support equipment 70 periodically or non-periodically receives the state information from each electric power generating unit 40 through the integrator 60.

The maintenance support control circuitry 72 determines the necessity of the maintenance of each electric power generating unit 40 based on the state information received from the electric power generating unit 40. The maintenance support control circuitry 72 displays the determined necessity of the maintenance as the maintenance information on the display 73. Moreover, the maintenance support control circuitry 72 may include a communication interface that transmits the maintenance information to external equipment of the maintenance support equipment 70. The external equipment is, for example, a terminal 101 (user terminal) of an owner or manager of the movable body 1. As shown in FIG. 10, the maintenance support control circuitry 72 may transmit the determined necessity of the maintenance as the maintenance information to the user terminal 101. The display 63 and the communication interface are examples of an output interface.

FIG. 11 is a diagram showing a configuration example of data stored by the maintenance support control circuitry 72. The maintenance support control circuitry 72 associates the received state information with the unit identification information, user identification information, and movable body identification information and stores them.

The user identification information is information for identifying the user who owns or uses the electric power generating unit 40 corresponding to the unit identification information. The movable body identification information is information for identifying the movable body including the electric power generating unit 40 corresponding to the unit identification information. The unit identification information is associated with the user identification information or the movable body identification information. Therefore, when the maintenance of the electric power generating unit 40 is required, the maintenance management company can easily contact the user of the electric power generating unit 40. For example, when the electric power generating units 40 mounted on the same movable body are replaced at the same timing, a period of time of the stop of the activity of the movable body can be reduced. The replacement timings of the electric power generating units 40 are easily determined in accordance with the movable body including the electric power generating units 40.

Moreover, in the example of FIG. 11, an “engine operation history,” an “electric power generation history,” “required electric power,” an “oil temperature,” and a “water temperature” are shown as the state information. The “engine operation history” includes, for example, data regarding the engine rotational frequency (i.e., the rotational speed) during the operation of the internal combustion engine 41, data regarding the throttle opening degree, and data regarding the temporal transition of the fuel supply amount of the fuel supplier 41d. Moreover, the “electric power generation history” is, for example, data regarding a temporal transition of the output electric power of the electric power generating unit 40. The “required electric power” is, for example, data regarding an electric power amount that is required of the electric power generating unit 40 by the integration ECU 62. The “oil temperature” is the temperature of the lubricating oil that lubricates, for example, the internal combustion engine 41. The “water temperature” is the temperature of the cooling water flowing through the cooling channel 57.

Moreover, in the example of FIG. 11, a “next replacement date,” “lives of parts,” a “cumulative damage amount,” and “presence or absence of abnormality” are shown as the maintenance information. The “next replacement date” is data regarding a scheduled replacement date of the electric power generating unit 40. The “lives of parts” is data regarding the lives and replacement timings of components, such as parts included in the electric power generating unit 40. The “next replacement date” and the “lives of parts” are input by, for example, the maintenance management company.

The “cumulative damage amount” is data regarding the amount of damage accumulated in the electric power generating unit 40 itself or in the component included in the electric power generating unit 40. The “presence or absence of abnormality” is data indicating whether or not there is an abnormality in the electric power generating unit 40 itself or in the component included in the electric power generating unit 40 or whether or not there is a possibility that an abnormality occurs in the electric power generating unit 40 itself or in the component included in the electric power generating unit 40. The “cumulative damage amount” and the “presence or absence of abnormality” are data generated by the maintenance support control circuitry 72 based on the state information received from the electric power generating unit 40.

Specifically, the memory of the maintenance support control circuitry 72 stores a determination program. The processor of the maintenance support control circuitry 72 reads the determination program to determine the necessity of the maintenance of the electric power generating unit 40. For example, the maintenance support control circuitry 72 generates the “cumulative damage amount” and the “presence or absence of abnormality” as the maintenance information based on the state information received from the electric power generating unit 40.

For example, the maintenance support control circuitry 72 determines from the “engine operation history,” the “electric power generation history,” and the “required electric power” whether or not the electric power required is output from the electric power generating unit 40. When the maintenance support control circuitry 72 determines that the electric power required is not output, the maintenance support control circuitry 72 determines that there is a possibility that there is an abnormality in the electric power generating unit 40. Or, for example, the maintenance support control circuitry 72 determines whether or not the electric power generation amount with respect to an engine control parameter, such as the engine rotational frequency or the throttle opening degree, is smaller than a past value (for example, the electric power generation amount immediately after the electric power generating unit 40 is mounted on the movable body 1). When the maintenance support control circuitry 72 determines that the electric power generation amount with respect to the engine control parameter is smaller than the past value, the maintenance support control circuitry 72 determines that there is a possibility that there is an abnormality in the electric power generating unit 40.

The maintenance support control circuitry 72 may transmit the generated maintenance information to the integration ECU 62 and the electric power generating units 40. For example, the integrator 60 may periodically or non-periodically receive the maintenance information from the maintenance support equipment 70 and display the maintenance information on the display 63. Moreover, each electric power ECU 47 may receive the maintenance information, generated by the maintenance support control circuitry 72, through the integrator 60. Each electric power ECU 47 may make the informer 49 perform informing based on the received maintenance information.

As above, the use states of the electric power generating units 40 configured as a module can be grasped. Therefore, even when the electric power generating units 40 are mounted on different places, the electric power generating units 40 can be managed as a whole. For example, the transportation, collection, maintenance, and management of the electric power generating units 40 can be made common among different movable bodies and facilities. Thus, such work can be more efficiently performed than when the work is separately performed. Moreover, since the electric power generating units 40 which require the maintenance are collected and managed together regardless of the movable bodies and the facilities, the collection of the maintenance parts and the securement of the work place can be performed, and this can improve the work efficiency. For example, the collected number of electric power generating units 40 that require the maintenance is easily increased, and the number of electric power generating units 40 to be maintained at once is easily increased.

As shown in FIG. 9, the movable bodies are collectively managed. Then, by acquiring the information of the electric power generating units 40 that satisfy a replacement requirement, the electric power generating units 40 which satisfy similar conditions (an operating time, an operating state, etc.) in the different movable bodies are extracted. Then, when it is found that the electric power generating unit 40 is likely to satisfy the replacement requirement, such electric power generating unit 40 is easily replaced in advance. Thus, to facilitate the prediction of the replacement, the integration ECU 62 may accumulate the information of the electric power generating unit 40 (the identification information of the internal combustion engine, the identification information of the power generator, a total operating period, a maintenance history (the number of times of the maintenance, the contents of the maintenance)) and the operation information of the movable body (an operating period after the maintenance, the type of the movable body, and a moving place) in combination.

### Other Embodiments

The foregoing has described the embodiments, and modifications, deletions, and additions may be made with respect to the above configurations within the scope of the present disclosure.

For example, the movable body 1 may be a train set including railcars. The fuel supply unit 20 and the electric power generating unit 40 may be mounted on at least one of the cars included in the train set. The integrator 60 may be mounted on each car. In this case, the integrator 60 may receive only the information of the fuel supply unit 20 and the electric power generating unit 40 mounted on the same car and may not receive the information of the fuel supply units 20 and the electric power generating units 40 mounted on the other cars. Moreover, one integrator 60 may be mounted on the train set. In this case, the integrator 60 may receive the information of all the fuel supply units 20 and the electric power generating units 40 mounted on the cars included in the train set.

Moreover, the movable body 1 is not limited to a track car and may be another type of land movable body including a driving wheel. For example, instead of the track car, the land movable body may be a car, such as a LTV, a truck, or a bus, which includes four or more wheels, or may be a utility vehicle, a motorcycle, a PTV, or the like. Moreover, the movable body may be a water movable body including propulsion equipment, an underwater movable body including propulsion equipment, or an air movable body that flies in the air. Examples of the water movable body includes a ship, a tanker, and a personal watercraft. One example of the underwater movable body is an underwater vehicle. Examples of the air movable body include an aircraft, a helicopter, and a drone. A rotating body may be a propeller.

A target on which the electric power generating unit 40 is mounted does not have to be the movable body. The target on which the electric power generating unit 40 is mounted may be, for example, a building or a facility which requires electric power.

The configuration of the fuel supply unit 20 is not limited to those described in the above embodiments. For example, the fuel supply unit 20 does not have to include at least one of the component 24, 25, 26, 31, 32, 33, 34, or 35 or does not have to include the components 24, 25, 26, 31, 32, 33, 34, and 35. For example, the number of fuel tanks included in the fuel supply unit does not have to be two and may be one or three or more.

Moreover, the fuel supply unit 20 does not have to include the fuel tanks 21 and 22. For example, the fuel tanks 21 and 22 may be fixed to a member of a movable body main body without through the support structural body 27 of the fuel supply unit 20. The fuel supply unit 20 may include the support structural body 27, the supply pipe 23 supported by the support structural body 27, and the like. When the fuel supply unit does not include the fuel tank, the fuel tank cannot be replaced by the work of replacing the fuel unit. However, the ease of maintenance of the supply pipe that supplies the fuel can be improved. For example, the supply pipe of the fuel supply unit which has been separated from the movable body main body can be subjected to a leak check. Thus, the maintenance work is easily performed.

The configuration of the electric power generating unit 40 is not limited to those described in the above embodiments. For example, the electric power generating unit 40 does not have to include at least one of the component 44, 45, 46, 47, 49, 51, 52, 53, 54, 55, 56, 57, or 58 or does not have to include the components 44, 45, 46, 47, 49, 51, 52, 53, 54, 55, 56, 57, and 58. For example, in the above embodiment, the electric power generating unit 40 includes the cooling medium pump 56. However, the cooling medium pump 56 may be located at the carbody 2 so as to be located outside the electric power generating unit 40. The electric power generating unit may include the electric power storing body. The internal combustion engine may use fuel other than the hydrogen gas.

The electric power generating unit and the fuel supply unit may constitute a single unit. To be specific, one of the electric power generating unit and the fuel supply unit may include all the components of the other unit.

The number of electric power generating units included in the movable body, the number of fuel supply units included in the movable body, and the arrangement of the electric power generating units and the fuel supply units are not limited to those described in the above embodiments. The movable body does not have to include the fuel supply unit. For example, the movable body may include a fuel tank that can supply the fuel to the electric power generating unit.

The shapes and structures of the support structural bodies 27 and 48 are not limited to those described in the above embodiments. The support structural body 27 of the fuel supply unit 20 does not have to have a box shape. For example, as with the support structural body 48 of the support structural body 27, the electric power generating unit 40 may include frames. The support structural body 48 of the electric power generating unit 40 does not have to include the frames shown in FIG. 3. For example, the support structural body 48 may have a box shape as with the support structural body 27 of the fuel supply unit 20.

The movable body may automatically move. For example, in the above embodiments, based on the requirement command received from the operator 6, the car control circuitry 7 generates the output command for controlling the electric motor 11 mounted on the railcar 1. However, the car control circuitry 7 may generate the output command by executing an automatic operation program stored in the memory.

In Embodiment 2 described above, the communication interface 46 of the electric power generating unit 40 may communicate with the maintenance support equipment 70 without through the integrator 60. To be specific, the electric power ECU 47 may associate the state information indicating the state of the electric power generating unit 40 with the unit identification information for identifying the electric power generating unit 40 and transmit the state information and the unit identification information to the maintenance support equipment 70 through the communication interface 46. The unit management system S2 may not include the integrator 60.

The management support equipment of Embodiment 1 described above may include not only the integrator 60 but also the maintenance support equipment. The management support equipment of Embodiment 2 described above may include only one of the integrator 60 and the maintenance support equipment 70.

Embodiment 2 describes that the maintenance support control circuitry 72 receives the state information. However, the maintenance support control circuitry 72 may not receive the state information. To be specific, the maintenance support control circuitry 72 may receive only the maintenance information generated by the integration ECU 62, not the state information. Therefore, a data communication fee for communication between the maintenance support equipment 70 and the movable body 1 can be reduced. In this case, instead of generating the maintenance information of the electric power generating unit 40 by the maintenance support control circuitry 72 based on the state information, the integration ECU 62 or the electric power ECU 47 of the electric power generating unit 40 may generate part of the maintenance information or the entire maintenance information based on the state information. Each of the state information and the maintenance information is not limited to the information shown in FIG. 11 and may be part of the information shown in FIG. 11 or may include information other than the information shown in FIG. 11.

The management support equipment may output the management support information other than the maintenance information. In addition to the management of the electric power generating unit 40, the management support equipment may output information regarding the maintenance of the fuel supply unit 20 (i.e., information regarding the replacement of the fuel supply unit 20, a remaining amount of fuel in the fuel tank, and the replacement of parts, such as a filter) as the management support information.

The driving source of the movable body is described as one example of the electric power consumption source Y. However, the electric power consumption source Y does not have to be mounted on the movable body.

The electric power generating units mounted on the movable body may be the same in configuration as each other or may be different in configuration from each other. For example, the types, performances, sizes, and the like of the components, such as the internal combustion engine and the power generator, included in the electric power generating units may be different among the electric power generating units. When the electric power generating units mounted on the movable body are different in configuration from each other, the integrator 60 may control the electric power generating operations of the electric power generating units 40 based on the differences of the electric power generating units 40. For example, when the electric power generating units 40 to which the integrator 60 transmits the control signals include: the electric power generating unit 40 which takes a long time to start; and the electric power generating unit 40 which takes a short time to start, the electric power output may be adjusted by using the electric power generating unit 40 which takes a short time to start. When there are a new type of electric power generating unit 40 and an old type of electric power generating unit 40, the output adjustment that urges the replacement of the old type of electric power generating unit 40 may be performed to properly execute depreciation.

The functionality of the components disclosed herein may be implemented using circuitry or processing circuitry which includes general purpose processors, special purpose processors, integrated circuits, ASICs (“Application Specific Integrated Circuits”), conventional circuitry or any combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware or processor.

### Disclosed Aspects

The following aspects disclose preferred embodiments.

### First Aspect

A unit management system including:
electric power generating units that generate electric power; and
management support equipment that receives information from the electric power generating units, wherein
each of the electric power generating units includes
   an internal combustion engine, an electric power generator that generates the electric power by rotational power of
   the internal combustion engine,
   a communication interface that is communicable with the management support equipment, and
   unit control circuitry configured to associate state information with unit identification information and transmit the state information and the unit identification information to the management support equipment through the communication interface, the state information indicating a state of the electric power generating unit, the unit identification information being information for identifying the electric power generating unit.

According to the above configuration, as the system, the electric power generating sources are distributedly located by using the electric power generating units. Therefore, as compared to when a single power source is used, the stop of the supply of the electric power is prevented, and the operation of the movable body is easily continued. Moreover, the management support equipment grasps the states of the electric power generating units. Therefore, even when the electric power generating units are used, the electric power generating units can be easily managed such that the total output electric power and the states of the units become appropriate.

### Second Aspect

The unit management system according to the first aspect, wherein the management support equipment transmits an operation command of each electric power generating unit to the electric power generating unit based on the state information of the electric power generating unit.

According to the above configuration, since the states of the electric power generating units are acquired, the operations of the electric power generating units are easily optimized.

### Third Aspect

The unit management system according to the first or second aspect, wherein the management support equipment includes a display that displays maintenance information based on the received state information of the electric power generating unit, the maintenance information being related to maintenance of the electric power generating unit.

According to the above configuration, the maintenance of each electric power generating unit is easily optimized.

### Fourth Aspect

The unit management system according to any one of the first to third aspects, wherein the electric power generating unit includes an informer that informs of maintenance information related to maintenance of the electric power generating unit.

According to the above configuration, even when the electric power generating units that are the same in shape as each other are located, the electric power generating unit that requires the maintenance is easily grasped.

### Fifth Aspect

The unit management system according to any one of the first to fourth aspects, wherein:
the management support equipment periodically or non-periodically receives the state information from each electric power generating unit; and
the management support equipment includes
   processing circuitry configured to determine necessity of maintenance of each electric power generating unit based on the state information received from the electric power generating unit and
   an output interface that outputs the determined necessity of the maintenance as maintenance information.

According to the above configuration, before the electric power generating unit becomes abnormal (stops its output), the replacement of the electric power generating unit is urged. Thus, the supply of the electric power is easily continued.

### Sixth Aspect

The unit management system according to any one of the first to fifth aspects, wherein the electric power generating units are the same in structure as each other.

According to the above configuration, the electric power generating unit is easily replaced. Moreover, maintenance parts are easily made common to each other.

### Seventh Aspect

The unit management system according to any one of the first to sixth aspects, wherein the communication interface includes a wireless communicator that wirelessly transmits information to the management support equipment.

According to the above configuration, since the connection is not the wired connection, the replacement and the movement are easy.

### Eighth Aspect

The unit management system according to any one of the first to seventh aspects, wherein:
the management support equipment receives electric power consumption information indicating the electric power consumed by an electric power consumption source to which the electric power is supplied from the electric power generating units; and
the management support equipment transmits an operation command to each electric power generating unit based on the state information and the electric power consumption information.

According to the above configuration, the operations of the electric power generating units are easily and individually optimized in accordance with the electric power consumption state of the electric power consumption source.

### Ninth Aspect

The unit management system according to any one of the first to eighth aspects, wherein:
the electric power generating units are mounted on a movable body;
the management support equipment determines a required electric power generation amount, which is to be transmitted to each electric power generating unit, in accordance with a traveling command of the movable body; and
the unit control circuitry of each electric power generating unit controls the internal combustion engine based on the required electric power generation amount determined by the management support equipment.

According to the above configuration, the management support equipment that manages the states of the electric power generating units also controls the electric power generating units based on the state information of the electric power generating units. Therefore, the control corresponding to the states of the electric power generating units can be realized.

### Tenth Aspect

The unit management system according to any one of the first to ninth aspects, wherein the internal combustion engine uses a hydrogen gas as fuel.

According to the above configuration, a purifier that purifies substances contained in an exhaust gas can be reduced in size, and the cost for the purifiers when the electric power generating units are located can be reduced. Moreover, even when the purifier is located at the electric power generating unit, the replacement frequency of the purifier due to deterioration can be reduced.

### Eleventh Aspect

The unit management system according to any one of the first to tenth aspects, wherein the state information includes information regarding damage over time.

According to the above configuration, the abnormalities, lives, and the like of the components of the electric power generating unit can be recognized from the state information.

### Twelfth Aspect

The unit management system according to any one of the first to eleventh aspects, wherein the management support equipment includes a memory that stores the unit identification information associated with user identification information, the user identification information being information for identifying a user who owns or uses the electric power generating unit corresponding to the unit identification information.

According to the above configuration, the management support equipment or a manager of the management support equipment can easily inform a user, who owns the electric power generating unit required to be replaced, of the necessity of the replacement of the unit.

### Thirteenth Aspect

An electric power generating unit including:
an internal combustion engine;
an electric power generator that generates electric power by rotational power of the internal combustion engine;
a communication interface; and
unit control circuitry configured to associate state information with unit identification information and transmit the state information and the unit identification information to external equipment through the communication interface, the state information indicating a state of the electric power generating unit, the unit identification information being information for identifying the electric power generating unit.

### Fourteenth Aspect

Management support equipment that receives information from electric power generating units that generate electric power,
the management support equipment including:
a communication interface that receives unit identification information and state information from each electric power generating unit, the unit identification information being information for identifying the electric power generating unit, the state information being associated with the unit identification information and indicating a state of the electric power generating unit;
a memory that stores the received state information associated with the unit identification information; and
processing circuitry configured to generate management support information based on the state information stored in the memory, the management support information being information for managing the electric power generating unit corresponding to the unit identification information associated with the state information.

### Fifteenth Aspect

A unit management method of managing electric power generating units that generate electric power,
the unit management method including:
acquiring state information from each electric power generating unit, the state information indicating a state of the electric power generating unit; and
   outputting management support information based on the acquired state information, the management support information being information for managing the electric power generating unit.

1. A unit management system comprising:
electric power generating units that generate electric power; and
management support equipment that receives information from the electric power generating units, wherein
each of the electric power generating units includes
an internal combustion engine, an electric power generator that generates the electric power by rotational power of the internal combustion engine,
a communication interface that is communicable with the management support equipment, and
unit control circuitry configured to associate state information with unit identification information and transmit the state information and the unit identification information to the management support equipment through the communication interface, the state information indicating a state of the electric power generating unit, the unit identification information being information for identifying the electric power generating unit.

2. The unit management system according to claim 1, wherein the management support equipment transmits an operation command of each electric power generating unit to the electric power generating unit based on the state information of the electric power generating unit.

3. The unit management system according to claim 1, wherein the management support equipment includes a display that displays maintenance information based on the received state information of the electric power generating unit, the maintenance information being related to maintenance of the electric power generating unit.

4. The unit management system according to claim 1, wherein the electric power generating unit includes an informer that informs of maintenance information related to maintenance of the electric power generating unit.

5. The unit management system according to claim 1, wherein:
the management support equipment periodically or non-periodically receives the state information from each electric power generating unit; and
the management support equipment includes
processing circuitry configured to determine necessity of maintenance of each electric power generating unit based on the state information received from the electric power generating unit and
an output interface that outputs the determined necessity of the maintenance as maintenance information.

6. The unit management system according to claim 1, wherein the electric power generating units are the same in structure as each other.

7. The unit management system according to claim 1, wherein the communication interface includes a wireless communicator that wirelessly transmits information to the management support equipment.

8. The unit management system according to claim 1, wherein:
the management support equipment receives electric power consumption information indicating the electric power consumed by an electric power consumption source to which the electric power is supplied from the electric power generating units; and
the management support equipment transmits an operation command to each electric power generating unit based on the state information and the electric power consumption information.

9. The unit management system according to claim 1, wherein:
the electric power generating units are mounted on a movable body;
the management support equipment determines a required electric power generation amount, which is to be transmitted to each electric power generating unit, in accordance with a traveling command of the movable body; and
the unit control circuitry of each electric power generating unit controls the internal combustion engine based on the required electric power generation amount determined by the management support equipment.

10. The unit management system according to claim 1, wherein the internal combustion engine uses a hydrogen gas as fuel.

11. The unit management system according to claim 1, wherein the state information includes information regarding damage over time.

12. The unit management system according to claim 1, wherein the management support equipment includes a memory that stores the unit identification information associated with user identification information, the user identification information being information for identifying a user who owns or uses the electric power generating unit corresponding to the unit identification information.

13. An electric power generating unit comprising:
an internal combustion engine;
an electric power generator that generates electric power by rotational power of the internal combustion engine;
a communication interface; and
unit control circuitry configured to associate state information with unit identification information and transmit the state information and the unit identification information to external equipment through the communication interface, the state information indicating a state of the electric power generating unit, the unit identification information being information for identifying the electric power generating unit.

14. (canceled)

15. A unit management method of managing electric power generating units that generate electric power,
the unit management method comprising:
acquiring state information from each electric power generating unit, the state information indicating a state of the electric power generating unit; and
outputting management support information based on the acquired state information, the management support information being information for managing the electric power generating unit.
